(19) United States
(12) Patent Application Publication
(10) Pub. No.: US 2018/0066692 A1
(43) Pub. Date: Mar. 8, 2018

(54) FASTENING AND SEALING DEVICES

(71) Applicant: Zephyros, Inc., Romeo, MI (US)

(72) Inventor: Emily Freeman, Rochester Hills, MI (US)

(21) Appl. No.: 15/598,826

(22) Filed: May 18, 2017

Related U.S. Application Data
(60) Provisional application No. 62/339,420, filed on May 20, 2016.

(51) Int. Cl. F16B 19/00; F16B 33/00; F16B 19/10

(52) U.S. Cl. CPC F16B 19/008; F16B 19/1036; F16B 33/004

(57) ABSTRACT

A method and device for sealing a space about a fastener in a cavity wall including a device having a sealing body which receives the fastener.

### TECHNICAL FIELD

The present teachings relate generally to a sealing member that includes a sealing body and fastener.

### BACKGROUND

The transportation industry continues to require methods of cavity sealing that provide improved functionality while simultaneously providing reduced weight, cost, and/or installation time. In addition, metal or plastic fasteners are generally utilized in a variety of locations within and adjacent to vehicle cavities. In order to adequately seal a cavity, any spaces about these fasteners must also be sealed. The added materials and installation time to seal about these fasteners presents significant challenges to the reduction efforts described above. In an effort to address these challenges, the teachings herein provide for a combination fastener and sealing body.

### SUMMARY OF THE INVENTION

In a first aspect the present teachings contemplate a device comprising a fastener having an extension portion extending outward from a head portion, the fastener being formed of a rigid material and a sealing body containing at least one opening for receiving the extension portion, the sealing body being formed of a non-rigid expandable material that is dissimilar from the rigid material of the fastener.

It is possible that the fastener is a bolt, a screw, a pop-rivet or a push-pin. The sealing body may be substantially free of any rigid material. The sealing body may consist of an expandable material that is activated by heat. It is possible that the fastener, the sealing body, or both are formed by an injection molding or extrusion process. A diameter of the head portion may exceed a diameter of the extension portion so that the diameter of the head portion prevents complete pull-through of the fastener through an opening in a cavity wall. The sealing body may substantially surround at least a portion of the extension portion. The expandable material of the sealing body may be a tacky material or is dry to the touch prior to expansion. The sealing body may be shaped to closely receive the extension portion in a friction-fit engagement prior to expansion of the sealing body. The sealing body includes a first portion and a second portion so that the diameter of the second portion exceeds the diameter of the first portion. Prior to expansion of the sealing body, the second portion of the sealing body may be in direct contact with the head portion of the fastener and the first portion of the sealing body may be substantially free of any direct contact with the head portion of the fastener.

The teachings herein further provide for a method comprising forming a fastener portion from a rigid material, forming a sealing body portion from a non-rigid expandable material having an opening for receiving the fastener and locating a portion of the fastener into the opening in the sealing body.

The teachings herein contemplate a device and method for the sealing of spaces around a fastener with an expandable sealing body. The expandable sealing body and fastener combinations disclosed herein may allow for effective sealing of a cavity. The device disclosed herein may further allow for simplified insertion into cavities where access is minimal, such that the device can be located within the cavity through relatively small openings (e.g., openings having a diameter smaller than that of the fastener).

### DESCRIPTION OF THE DRAWINGS

FIG. 1 shows a side profile view of an illustrative example of the sealing body and fastener of the present teachings.

FIG. 2 shows a side profile views of the sealing body of FIG. 1 receiving he fastener of FIG. 1.

FIG. 3 shows a side profile view of the sealing body and fastener of FIG. 1 being located into an opening in a cavity wall prior to expansion of the sealing body.

FIG. 4 shows the view of FIG. 3 after expansion of the sealing body.

FIGS. 5A and 5B show side profile and top down views respectively of an exemplary sealing body in accordance with the present teachings.

FIGS. 6A, 6B, and 6C show the sealing body of FIG. 5 receiving the fastener, being located into a cavity opening, and post-expansion of the sealing body respectively.

### DETAILED DESCRIPTION

The present teachings allow for improved sealing of a cavity with a sealing body and fastener. The device disclosed herein may include an expandable sealing body and fastener. The fastener may be comprised of a rigid material that is dissimilar to that of the sealing body. The sealing body may comprise or may consist essentially of a non-rigid expandable material. The sealing body and fastener may be injection molded or extruded. The sealing body and fastener may be co-injection molded or co-extruded.

This application is related to and claims the benefit of the priority date of U.S. Provisional Application Ser. No. 62/339,420, filed on May 20, 2016. The entirety of that application is hereby incorporated by reference for all purposes.

The sealing body may be substantially free of any rigid material. Preferably, the sealing body consists essentially of an expandable material. The sealing body may be formed so that a portion of the sealing body lies in direct planar contact with a portion of the fastener. The sealing body may form a mechanical connection with the fastener. The sealing body and fastener may be engaged in a friction fit with one another. The portion of the sealing body located in contact with the fastener may be adhered to the fastener by a tacky nature of the expandable material that forms the sealing body. The sealing body and fastener may be adhered to one another during an injection molding process. The connection between the sealing body and fastener may be of sufficient strength so that when the fastener is located into an opening in a cavity wall, the sealing body and fastener remain connected at least until the expandable material undergoes expansion. The fastener may act to force a portion of the sealing body through an opening so that the sealing body expands on both surfaces adjacent the opening in a cavity.

The sealing body may be shaped to match the shape of the fastener it receives. As one non-limiting example, a substantially circular extension portion of a fastener may be received by a substantially circular opening in the sealing body. A substantially rectangular extension portion of a fastener may be received by a substantially rectangular opening in the sealing body. The length of the sealing body may be less than the length of the extension portion of the fastener. The length of the sealing body may be less than one half, less than one third or even less than one fourth the length of the extension portion of the fastener.

The expandable material of the sealing body may be a tacky material. It may include a removable film layer to allow for handling. The tacky nature of the sealing body may promote adhesion between the sealing body and fastener. Alternatively, the expandable material may be substantially dry to the touch.

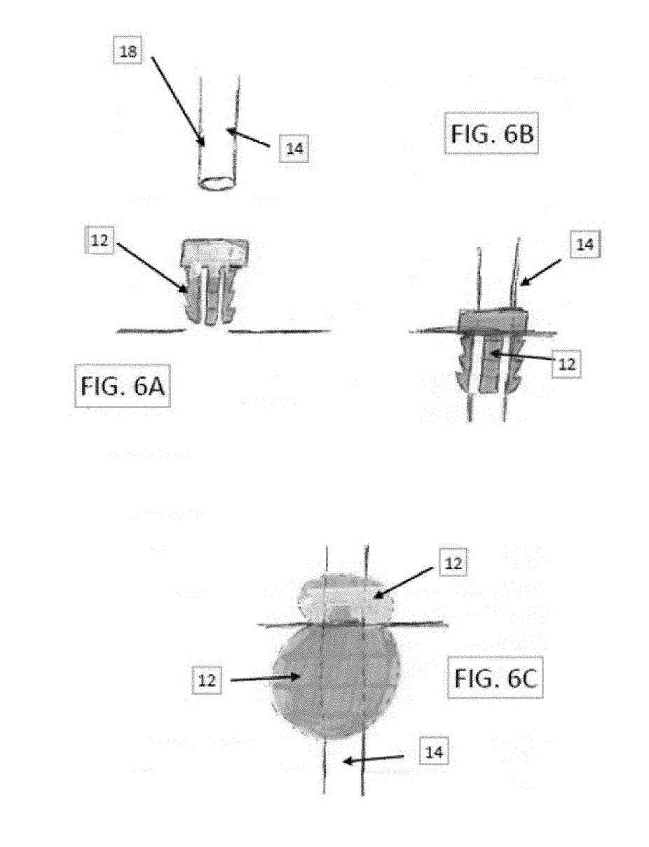

The fastener may be a tree fastener. The fastener may be a push-pin fastener. The fastener may be a trapezoidal push-pin fastener. The fastener may be a fastener as disclosed in U.S. Pat. No. 8,029,222, incorporated by reference herein for all purposes. The fastener may include a head portion and extension portion such that the diameter of the head portion exceeds the diameter of the extension portion so that the diameter of the head portion prevents complete pull-through of the fastener through an opening in a cavity wall. The sealing body may include one or more wings, one or more of which may engage a cavity wall surrounding an opening in the cavity wall (see for example FIGS. 5 and 6). The wings may be located at evenly spaced about intervals along the sealing body.

The materials may also include a film layer, such as that disclosed in U.S. Patent Publication Nos. 2004/0076831 and 2005/0260399, incorporated by reference herein for all purposes. The film layer may be used to cover a material that is tacky to the touch. The film layer may be removed from the material prior to application of the material to a vehicle structure, such that the film will reveal a tacky surface of the material that will adhere to the structure.

The size of the expandable sealing body and fastener may depend upon the size of the opening through which the expandable sealing body and fastener is located. The thickness of the expandable sealing body may be at least about 0.1 mm. The thickness of the expandable sealing body may be less than about 50 mm. The thickness of the expandable sealing body may be from about 0.5 mm to about 20 mm. The thickness of the expandable sealing body may be less than about 2 mm. The thickness of the expandable sealing body may be from about 0.2 mm to about 5 mm.

After placement of the expandable sealing body and fastener through an opening (and optionally into a cavity), the expandable material may expand according to a predetermined set of conditions. For example, exposure to certain levels of heat (inductive or otherwise) may cause the expandable material to expand. The expandable sealing body and fastener may expand at least about 100%. The expandable material may expand less than about 2,000%. The expandable material may expand at least about 500%, at least about 1,000%, or more. The expandable material may expand less than about 1,000% or even less than about 500%.

The expandable sealing body may be generally dry to the touch or tacky and may be shaped in any form of desired pattern, placement, or thickness, but is preferably of substantially uniform thickness. Though other heat-activated materials are possible for the expandable sealing body and fastener, a preferred heat activated material is an expandable polymer or plastic, and preferably one that is foamable. The expandable sealing body and fastener may be a relatively high expansion foam having a polymeric formulation that includes one or more of an epoxy resin, an acetate (e.g. ethylene vinyl acetate), a thermoplastic polyether, an acrylate and/or a methacrylate (e.g., a copolymer of butyl acrylate and methyl acrylate), an epoxy/elastomer adduct, and one or more fillers (e.g., a clay filler, and/or a nanoparticle-containing filler). Preferred thermally expandable materials are disclosed in U.S. Pat. Nos. 7,313,865; 7,125,461; and 7,199,165, incorporated by reference herein for all purposes. For example, and without limitation, the foam may also be an EVA/rubber based material, including an ethylene copolymer or terpolymer that may possess an alpha-olefin. As a copolymer or terpolymer, the polymer is composed of two or three different monomers, i.e., small molecules with high chemical reactivity that are head portionable of linking up with similar molecules. Suitable expandable materials include those available from L&L Products, Inc. under the designations L7220, L2821, L1066, L205, L2010, L2105, L2108A, L2806, L2811, L4200, L4141, L4161, L4315, L5510, L5520, L5540, L5600, L5601, L7102, and L7104. The expandable sealing body may be a die cut material.

A number of baffling or sealing foams may also be used for the expandable sealing body and fastener. A typical foam includes a polymeric base material, such as one or more ethylene-based polymers which, when compounded with appropriate ingredients (typically a blowing and curing agent), will expand and cure in a reliable and predictable manner upon the application of heat or the occurrence of a particular condition. From a chemical standpoint for a thermally-activated material, the foam is usually initially processed as a flowable material before curing, and upon curing, the material will typically cross-link making the material incapable of further flow.

The expandable sealing body can be formed of other materials provided that the material selected is heat-activated or otherwise activated by an ambient condition (e.g. moisture, pressure, time or the like) and cures under appropriate conditions for the selected application. One such material is the epoxy based resin disclosed in U.S. Pat. No. 6,131,897, the teachings of which are incorporated herein by reference. Some other possible materials include, but are not limited to, polyolefin materials, copolymers, and terpolymers with at least one monomer type such as an alpha-olefin, phenol/formaldehyde materials, phenoxy materials, and polyurethane materials with high glass transition temperatures. Additional materials may also be used such as those disclosed in U.S. Pat. Nos. 5,766,719; 5,755,486; 5,575,526; and 5,932,680, incorporated by reference herein for all purposes.

In applications where the expandable sealing body comprises a heat activated material, an important consideration involved with the selection and formulation of the material is the temperature at which a material cures and, if expandable, the temperature of expansion. Typically, the material becomes reactive (cures, expands, or both) at higher processing temperatures, such as those encountered in an automobile assembly plant, when the material is processed along with the automobile structures at elevated temperatures or at higher applied energy levels, e.g., during coating (e.g., e-coat, paint, or clearcoat) curing steps. While temperatures encountered in an automobile assembly operation may be in the range of about 148.89° C. to 204.44° C. (about 300° F. to 400° F.) for body shop applications (e.g., e-coat) and, for paint shop applications, are commonly about 93.33° C. (about 200° F.) or slightly higher (e.g., 120° C. to 150° C.).

The fastener may be formed of a rigid material, which may be a metal or polymeric material. The fastener may be formed of a nylon material. The fastener may be capable of securing multiple layers or types of materials to a structure. The fastener may be capable of receiving an additional fastening means located thereon after the fastener has been located into an opening. The fastener may be shaped as a partial arrowhead fastener. The fastener may have flexible wings such as that disclosed in U.S. Pat. No. 8,029,222 (incorporated by reference herein for all purposes), so that it can be located into an opening having a diameter that is smaller than the largest diameter of the fastener.

The expandable sealing body and fastener of the present invention may be installed into an automotive vehicle although it may be employed for other articles of manufacture such as boats, buildings, furniture, storage containers or the like. The expandable sealing body and fastener may be used to seal a variety of components of an automotive vehicle including, without limitation, body components (e.g., panels), frame components (e.g., hydroformed tubes), pillar structures (e.g., A, B, C or D-pillars), bumpers, roofs, bulkheads, instrument panels, wheel wells, floor pans, door beams, hem flanges, vehicle beltline applications, doors, door sills, rockers, decklids, hoods or the like of the automotive vehicle.

The materials and formation process of the present invention create a simplified lightweight sealing device that can be easily customized to fit any cavity. The fastener may be molded into the sealing body.

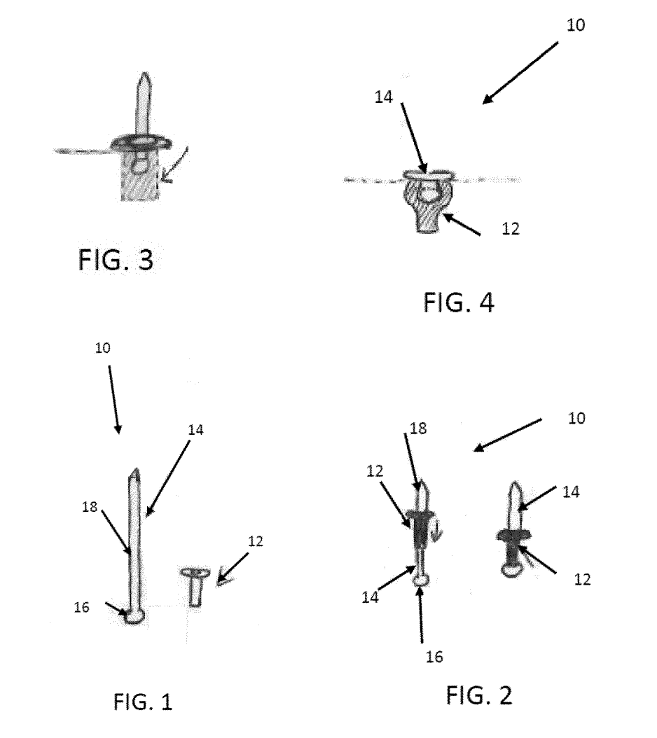

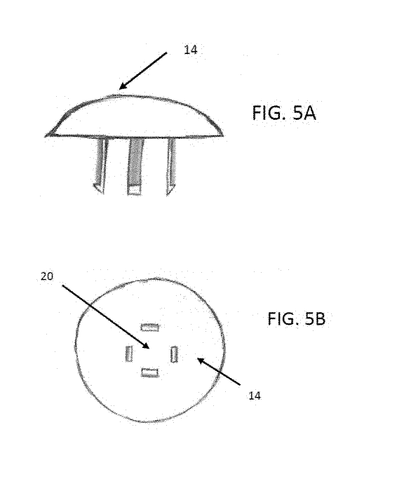

As shown for example in FIGS. 1 through 4, the device 10 may include a sealing body 12 and a fastener 14. The fastener 14 may include a head portion 16 and extension portion 18.

As shown in FIGS. 5A-5B, the sealing body may be formed so that a center portion 20 is easily removed upon insertion of a fastener.

As shown for example in FIGS. 6A-6C, the sealing body 12 may receive the fastener 14 when in a green state (e.g., prior to expansion). As shown specifically in FIG. 6C, upon expansion, the sealing body 12 may expand on both surfaces surrounding an opening which receives the fastener.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components, or steps identified, and such other elements ingredients, components, or steps that do not materially affect the basic and novel characteristics of the combination. The use of the terms “comprising” or “including” describe combinations of elements, ingredients, components, or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A device comprising:
a fastener having an extension portion extending outward from a head portion, the fastener being formed of a rigid material; and
a sealing body containing at least one opening for receiving the extension portion, the sealing body being formed of a non-rigid expandable material that is dissimilar from the rigid material of the fastener.

2. The device of claim 1, wherein the fastener is a bolt, a screw, a pop-rivet or a push-pin.

3. The device of claim 1, wherein the sealing body is substantially free of any rigid material.

4. The device of claim 1, wherein the sealing body consists of an expandable material that is activated by heat.

5. The device of claim 1, wherein the fastener, the sealing body, or both are formed by an injection molding or extrusion process.

6. The device of claim 1, wherein a diameter of the head portion exceeds a diameter of the extension portion so that the diameter of the head portion prevents complete pull-through of the fastener through an opening in a cavity wall.

7. The device of claim 1, wherein the sealing body substantially surrounds at least a portion of the extension portion.

8. The device of claim 1, wherein the expandable material of the sealing body is a tacky material or is dry to the touch prior to expansion.

9. The device of claim 1 wherein the sealing body is shaped to closely receive the extension portion in a friction-fit engagement prior to expansion of the sealing body.

10. The device of claim 1, wherein the sealing body includes a first portion and a second portion so that the diameter of the second portion exceeds the diameter of the first portion.

11. The device of claim 10, wherein prior to expansion of the sealing body, the second portion of the sealing body is in direct contact with the head portion of the fastener and the first portion of the sealing body is substantially free of any direct contact with the head portion of the fastener.

12. A method comprising:
forming a fastener portion from a rigid material;
forming a sealing body portion from a non-rigid expandable material having an opening for receiving the fastener;
locating a portion of the fastener into the opening in the sealing body.
